(19) United States
(12) Patent Application Publication
(10) Pub. No.: US 2004/0194831 A1
(43) Pub. Date: Oct. 7, 2004

(54) System and method including a fluid actuated fuel tank isolation valve

(76) Inventor: David W. Balsdon, Chatham (CA)

Correspondence Address: MORGAN LEWIS & BOCKIUS LLP, 1111 PENNSYLVANIA AVENUE NW, WASHINGTON, DC, 20004, US

(21) Appl. No.: 10/812,874

(22) Filed: Mar. 31, 2004

Related U.S. Application Data
(60) Provisional application No. 60/459,351, filed on Apr. 1, 2003.

(51) Int. Cl. F02M 33/02

(52) U.S. Cl. 137/587; 123/520

(57) ABSTRACT

A system and method that controls evaporative emissions of a volatile fuel. The system includes a fuel tank with a refueling tube, and includes a fuel tank isolation valve. The fuel tank isolation valve includes a housing, a diaphragm, and an actuator. The housing includes a first port, which is in fuel vapor communication with the fuel tank, and a second port. The diaphragm is movable with respect to the housing between first and second configurations. The first configuration substantially prevents fuel vapor flow between the first and second ports, and the second configuration permits fuel vapor flow between the first and second ports. And the actuator, which is in fluid communication with the refueling tube, acts on the diaphragm.

### CLAIM FOR PRIORITY

This application claims the benefit of the earlier filing date of U.S. Provisional Application 60/459,351, filed 1 Apr. 2003, which is incorporated herein in its entirety by reference.

### FIELD OF THE INVENTION

This disclosure generally relates to a fuel tank isolation control valve. In particular, this disclosure is directed to an evaporative emission control system including a fuel tank isolation control valve to control the flow of fuel vapor from a fuel tank of a vehicle.

### BACKGROUND OF THE INVENTION

Prior to legislation requiring vehicles to store hydrocarbon vapors that are generated when refueling a vehicle, it was known that a simple orifice structure could maintain a positive pressure in a fuel tank to retard vapor generation. However, such orifice structures could no longer be used with the advent of requirements controlling on-board refueling. It is believed that, on some vehicles, the orifice structure was simply deleted, and on other vehicles, the orifice structure was replaced with a diaphragm-actuated pressure relief valve.

It is believed that it is necessary on some vehicles to maintain an elevated pressure in the fuel tank to suppress the rate of fuel vapor generation and to minimize hydrocarbon emissions to the atmosphere. It is believed that under hot ambient temperature conditions or when the fuel is agitated, e.g., when a vehicle is operated on a bumpy road, the amount of fuel vapor generated can exceed the amount of fuel vapor that can be purged by the engine. It is believed that a purge canister can become hydrocarbon saturated if these conditions occur and are maintained for an extended period. It is believed that such a hydrocarbon saturated purge canister is unable to absorb the additional fuel vapors that occur during vehicle refueling, and that hydrocarbon vapors are released into the atmosphere.

It is believed that there is a need to provide a valve that that overcomes the drawbacks of orifice structures and diaphragm-actuated pressure relief valves.

### SUMMARY OF THE INVENTION

The present invention provides a system that controls evaporative emissions of a volatile fuel. The system includes a fuel tank with a refueling tube, a fuel tank isolation valve, a passage in fluid communication with the refueling tube, and a fuel vapor collection canister. The fuel tank defines a liquid fuel space and a fuel vapor headspace above the liquid fuel space. The fuel tank isolation valve includes a housing, a diaphragm, and a coil spring. The housing defines a chamber and an interior aperture, and includes first and second ports in fluid communication with the chamber. The first port is in fuel vapor communication with the fuel vapor headspace of the fuel tank, and a fuel vapor flow path between the first and second ports passes through the interior aperture. The diaphragm is movable with respect to the housing between a first configuration and a second configuration. In the first configuration, the diaphragm (i) occludes the interior aperture, (ii) divides the chamber into first, second and third sub-chambers, and (iii) substantially prevents fuel vapor flow along the fuel vapor flow path. In the second configuration, the diaphragm (i) divides the chamber into the first sub-chamber and a combination of the second and two sub-chambers, and (ii) permits generally unrestricted fuel vapor flow along the fuel vapor flow path. The coil spring is disposed in the first sub-chamber and biases the diaphragm toward the first configuration. The passage provides fluid communication between the refueling tube and the first sub-chamber. And the fuel vapor collection canister is in fuel vapor communication with the second port of the fuel tank isolation valve.

The present invention also provides a system that controls evaporative emissions of a volatile fuel. The system includes a fuel tank with a refueling tube, and includes a fuel tank isolation valve. The fuel tank isolation valve includes a housing, a diaphragm, and an actuator. The housing includes a first port, which is in fuel vapor communication with the fuel tank, and a second port. The diaphragm is movable with respect to the housing between first and second configurations. The first configuration substantially prevents fuel vapor flow between the first and second ports, and the second configuration permits fuel vapor flow between the first and second ports. And the actuator, which is in fluid communication with the refueling tube, acts on the diaphragm.

The present invention also provides a method of controlling fuel vapor flow between a fuel vapor headspace of a fuel tank and a fuel vapor collection canister. The method includes permitting with a fuel tank isolation valve the fuel vapor flow from the fuel vapor headspace of the fuel tank to fill the fuel vapor collection canister, preventing with the fuel tank isolation valve the fuel vapor flow from the fuel vapor headspace of the fuel tank during purging of the fuel vapor collection canister, and supplying vacuum to actuate the fuel tank isolation valve during refueling of the fuel tank.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a schematic illustration of an evaporative emission control system including a fluid actuated fuel tank isolation valve according to the present invention.

FIG. 2 is a sectional view of an embodiment of the fluid actuated fuel tank isolation valve shown in FIG. 1.

### DETAILED DESCRIPTION OF THE PREFERRED EMBODIMENT

As it is used herein, the term “fluid” can refer to a gaseous phase, a liquid phase, or a mixture of the gaseous and liquid phases. The term “fluid” preferably refers to the gaseous phase of a volatile liquid fuel, e.g., a fuel vapor. The term “peripheral” preferably refers to a portion of a body that is proximate an edge of the body, and the term “central” preferably refers to a portion of a body that is inboard of the edge portion. The term “central” is not limited to the geometric center of the body.

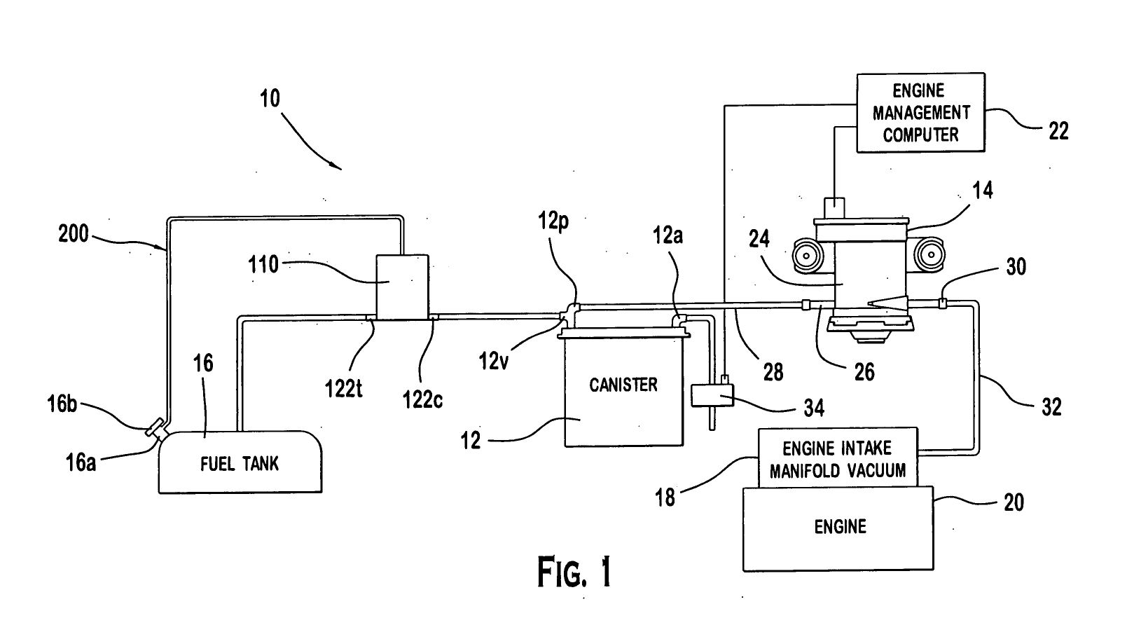

Referring initially to FIG. 1, an evaporative emission control system 10, e.g., for a motor vehicle, includes a fuel vapor collection canister 12, e.g., a carbon or charcoal canister, and a canister purge solenoid valve 14 connected between a fuel tank 16 and an intake manifold 18 of an internal combustion engine 20. An engine control management computer 22 supplies a purge valve control signal for operating the canister purge solenoid valve 14.

Canister purge solenoid valve 14 preferably includes a housing 24 having an inlet port 26 and an outlet port 30. The inlet port 26 is in fluid communication, via a conduit 28, with a purge port 12p of the fuel vapor collection canister 12. The outlet port 30 is in fluid communication, via a conduit 32, with intake manifold 18. An operating mechanism is disposed within the housing 24 for opening and closing an internal passage that provides fluid communication between the inlet port 26 and the outlet port 30. The mechanism includes a spring that biases a valve element to a normally closed arrangement, i.e., so as to occlude the internal passage between the inlet port 26 and the outlet port 30. When the operating mechanism, e.g., a solenoid, is energized by a purge valve control signal from the engine control management computer 22, an armature opposes the spring to open the internal passage so that flow can occur between the inlet port 26 and the outlet port 30.

According to a preferred embodiment, an ambient vent valve 34 is in fuel vapor communication between the ambient port 12a of canister 12 and the ambient environment. A filter (not shown) can be interposed between the ambient vent valve 34 and the ambient environment. The ambient vent valve 34 is normally open, i.e., so as to permit unrestricted fluid communication with the ambient environment, until the engine control management computer 22 supplies an ambient vent valve control signal that closes the ambient vent valve 34. Preferably, the ambient vent valve 34 is normally open to facilitate charging and discharging of the canister 12, and can be closed to facilitate leak testing of the evaporative emission control system 10.

The canister purge solenoid valve 14 can be used to purge free hydrocarbons that have been collected in the fuel vapor collection canister 12. The free hydrocarbons that are purged from the fuel vapor collection canister 12 are combusted by the internal combustion engine 20.

A refueling tube 16a extends from an inlet, which is generally occluded by a cap 16b, to an outlet that is coupled to the fuel tank 16. In a known manner, when the cap 16b is removed from the refueling tube 16a, a fuel filler nozzle (not shown) can be inserted through the inlet into the refueling tube 16a. Preferably, a liquid fuel, e.g., gasoline, is supplied via the refueling tube 16a from the fuel filler nozzle (not shown) to the fuel tank 16. As the fuel is supplied through the refueling tube 16a, a vacuum is drawn in the refueling tube 16a. When the fuel tank 16 is not being refueled, the cap 16b is placed on the refueling tube 16a so as to generally occlude the inlet of the refueling tube 16a. Preferably, the cap 16b provides a one-way check valve (not shown) that allows air from the ambient environment to be drawn into the fuel tank 16 as fuel is depleted.

A fuel tank isolation valve 110 is connected in series between a vapor-dome or headspace, i.e., the gaseous portion within the fuel tank 16, and a valve port 12v of the fuel vapor collection canister 12.

A vapor dome pressure level that is approximately 1 inch of water above atmospheric pressure has been determined to suppress fuel vapor generation in the fuel tank 16. Higher pressures, e.g., as much as 10 inches water above atmospheric pressure, can also suppress fuel vapor generation.

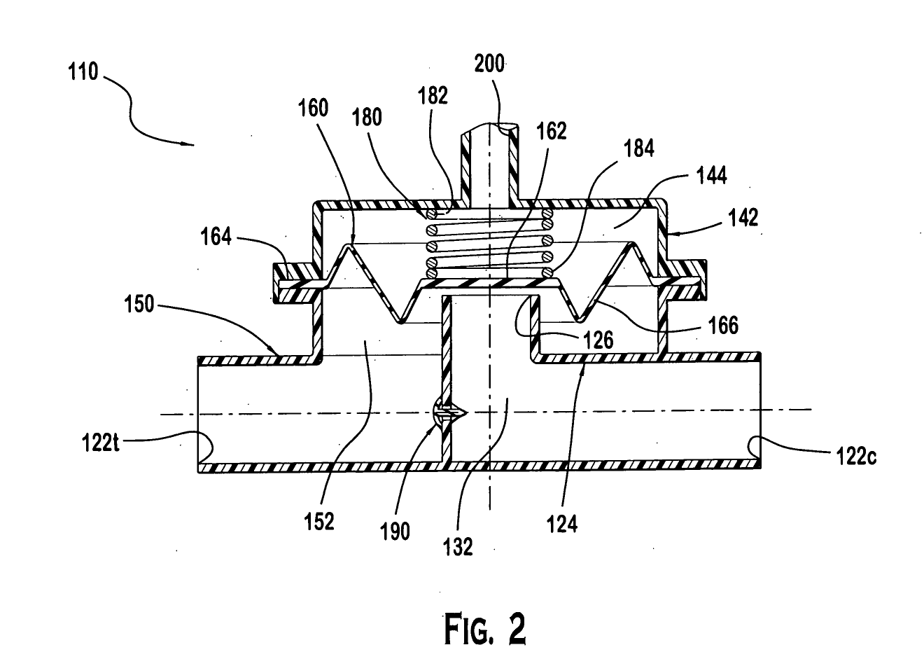

Referring additionally to FIG. 2, the fluid actuated fuel tank isolation valve 110 includes a housing 120, a diaphragm 160, and a resilient element 180. The housing 120 defines within its exterior walls a chamber. The housing 120 includes an inlet port 122t for ingress into the chamber of fuel vapor from the headspace of the fuel tank 16, and includes an outlet port 122c for egress of fuel vapor from the chamber to the fuel vapor collection canister 12. Fuel vapor is communicated within the housing 120 between the inlet port 122t, which is at an inlet pressure level, and the outlet port 122c, which is at an outlet pressure level. Typically, the inlet pressure level is greater than ambient pressure, while the outlet pressure level is equal to or less than ambient pressure.

The housing 120 also includes an interior partition 124 that defines an aperture 126. The diaphragm 160 divides the housing 120 into a body segment 142 and a cover segment 150. Thus, the chamber defined by the housing 120 may be considered to be composed of three sub-chambers. A first sub-chamber 144 encloses the resilient element 180, and is defined by the diaphragm 160 and the cover segment 142 of the housing 120. A second sub-chamber 132 extends from the aperture 126 to the outlet port 122c, and is defined by the interior partition 124, the diaphragm 160, and the housing 120. A third sub-chamber 152 extends from the inlet port 122t to the aperture 126, and is defined by the interior partition 124, the diaphragm 160, and the body segment 142 of the housing 120.

The diaphragm 160 is movable, e.g., flexible, with respect to the housing 120 between a first configuration (not shown) and a second configuration (shown in FIG. 2). At the first configuration, the diaphragm 160 occludes the aperture 126, divides the chamber into the three sub-chambers, and substantially prevents fuel vapor flow between the inlet port 122t and the outlet port 122c. At the second configuration, the diaphragm 160 divides the chamber into only two sub-chambers, i.e., the second and third sub-chambers 132,152 are combined in fluid communication, and permits fuel vapor flow between the inlet port 122t and the outlet port 122c.

The diaphragm 160 can include a central portion 162, a peripheral portion 164, and an intermediate portion 166 that extends between the central and peripheral portions 162,164. The central portion 162 is operatively engaged, e.g., biased, by the resilient element 180. The peripheral portion 164 is fixed with respect to the housing 120, e.g., sandwiched between the body and cover segments 150,142 of the housing 120. The intermediate portion 166 includes a relatively flexible material as compared to the central portion 162. Preferably, the central portion 162 of the diaphragm 160 includes a rigid plate, i.e., sufficiently rigid to avoid appreciable deformation as a result of a pressure differential between the inlet and outlet ports 122t,122c when the diaphragm is at the first configuration. The intermediate portion 166 can include a convolute, e.g., as shown in FIG. 2. Of course, other configurations

The diaphragm 160 can be integrally formed, e.g., molded, as a homogenous material, with the central portion 162 having a thicker cross-section than the intermediate portion 166. Preferably, the homogenous material is impermeable to hydrocarbon migration.

The resilient element 180, which can be a coil spring, can have a first end 182 engaging the cover segment 142 of the housing 120, and can have a second end 184 engaging the central portion 162 of the diaphragm 160. The resilient element 180 biases the diaphragm 160 toward the first configuration, i.e., such that the central portion 162 of the diaphragm 160 occludes the aperture 126.

A check valve 190 can be provided in the interior partition 124. The check valve 190 enables unidirectional fluid communication between the second and third sub-chambers 132,152. For example, the check valve 190 can act as a safety device to relieve excess vacuum in the fuel tank 16.

A passage 200, e.g., a conduit or pipe, provides fluid communication between the refueling tube 16a and the first sub-chamber 144. The passage 200 supplies to the first sub-chamber 144 the vacuum that is developed in the refueling tube 16a during refueling. The vacuum in the first sub-chamber 144 acts as an actuator that assists in displacing the diaphragm 160 toward the second configuration, i.e., such that fuel vapor flow is permitted between the inlet and outlet ports 122t,122c. During refueling of the fuel tank 16, the diaphragm 160 is also displaced toward the second configuration by virtue of the positive pressure that is developed in the fuel tank 16 as the fuel is added to the fuel tank 16.

A method of controlling fuel vapor flow between the evaporative emission space of the fuel tank 16 and the fuel vapor collection canister 12 will now be described. Using the fuel tank isolation valve 110, moving toward or positioning the diaphragm 160 at the first configuration is enhanced by a pressure level below atmospheric pressure at the outlet port 122c, and the diaphragm 160 is moved to the second configuration in response to a first pressure level above atmospheric pressure at the inlet port 122t. The biasing force of the resilient element 180 is selected such that the first pressure level suppresses fuel vapor generation in the fuel tank 16. Preferably, the first pressure level is approximately one inch of water above atmospheric pressure.

In response to a third pressure level below atmospheric pressure at the inlet port 122t, the check valve 190 can equalize pressure between the inlet and outlet ports 122t,122c, e.g., to relieve excess vacuum in the fuel tank 16. Preferably, the third pressure level is approximately six inches of water below atmospheric pressure

The evaporative emission control system 10, the fluid actuated fuel tank isolation valve 110, and the method that are described above provide numerous advantages. These advantages include mechanical operation (i.e., no electrical operation), eliminating a wiring connection to the engine control management computer 22, relieving excess naturally occurring vacuum as fuel in the fuel tank 16 cools, and facilitating refueling of the fuel tank 16. During refueling, the vacuum created by liquid flow through the refueling tube 16a will assist in displacing the diaphragm 160 from the aperture 126, and prevent premature shut-off of the fuel filler nozzle (not shown). Further, isolating the fuel tank 16 from the rest of the evaporative emission control system 10 prevents purge vacuum from entering the fuel tank 16, reduces hydrocarbon spikes during aggressive purging, minimizes engine falter due to hydrocarbon spikes, and maximizes purge capability of the fuel vapor collection canister 12, which aids in reducing hydrocarbons stores in the fuel vapor collection canister 12. Moreover, the fluid actuated fuel tank isolation valve 110 according to the present invention enables regulation of pressure in the fuel tank 16 to a level that suppresses fuel vapor generation without any electrical input, and still allows refueling.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A system for controlling evaporative emissions of a volatile fuel, the system comprising:
a fuel tank including a refueling tube, the fuel tank defining a liquid fuel space and a fuel vapor headspace above the liquid fuel space;
a fuel tank isolation valve including:
a housing defining a chamber and an interior aperture, the housing including first and second ports in fluid communication with the chamber, the first port being in fuel vapor communication with the fuel vapor headspace of the fuel tank, and a fuel vapor flow path between the first and second ports passing through the interior aperture;
a diaphragm movable with respect to the housing between a first configuration and a second configuration, the diaphragm in the first configuration:
i) occludes the interior aperture,
ii) divides the chamber into first, second and third sub-chambers, and
iii) substantially prevents fuel vapor flow along the fuel vapor flow path,
and the diaphragm in the second configuration:
i) divides the chamber into the first sub-chamber and a combination of the second and two sub-chambers, and
ii) permits generally unrestricted fuel vapor flow along the fuel vapor flow path; and
a coil spring being disposed in the first sub-chamber and biasing the diaphragm toward the first configuration;
a passage providing fluid communication between the refueling tube and the first sub-chamber; and
a fuel vapor collection canister being in fuel vapor communication with the second port of the fuel tank isolation valve.

2. The system according to claim 1, wherein the liquid fuel space is proximate a bottom of the fuel tank and the fuel vapor headspace is proximate a top of the fuel tank.

3. The system according to claim 2, wherein the refueling tube comprises an inlet and an outlet, the inlet is disposed above the fuel tank and the outlet is disposed proximate the bottom of the fuel tank.

4. The system according to claim 3, wherein the refueling tube comprises a tap in fluid communication with the passage, the tap being positioned above the fuel tank.

5. The system according to claim 4, wherein the tap is within eight inches of the inlet of the refueling tube.

6. The system according to claim 3, further comprising:
a cap occluding the inlet of the refueling tube.

7. The system according to claim 6, wherein the cap comprises an orifice permitting air to flow into the refueling tube when the cap occludes the inlet of the refueling tube.

8. A system for controlling evaporative emissions of a volatile fuel, the system comprising:
a fuel tank including a refueling tube; and
a fuel tank isolation valve including:
a housing including first and second ports, the first port being in fuel vapor communication with the fuel tank;
a diaphragm movable with respect to the housing between a first configuration and a second configuration, the first configuration substantially preventing fuel vapor flow between the first and second ports, and the second configuration permitting fuel vapor flow between the first and second ports; and
an actuator acting on the diaphragm, the actuator being in fluid communication with the refueling tube.

9. The system according to claim 8, wherein the housing defines a chamber and an aperture, a fuel vapor flow path in the chamber between the first and second ports passes through the aperture.

10. The system according to claim 9, wherein the diaphragm in the first configuration occludes the aperture.

11. The system according to claim 9, wherein the diaphragm in the first configuration divides the chamber into first, second and third sub-chambers, and the diaphragm in the second configuration divides the chamber into the first sub-chamber and a combination of the second and third sub-chambers.

12. The system according to claim 11, wherein the actuator includes the first sub-chamber.

13. The system according to claim 8, wherein the isolation valve comprises a resilient element biasing the diaphragm toward the first configuration, the resilient element includes a first end engaging the housing and a second end engaging the diaphragm.

14. The system according to claim 13, wherein the resilient element comprises a compression spring.

15. The system according to claim 13, wherein the diaphragm comprises:
a central portion engaging the second end of the resilient element;
a peripheral portion being fixed with respect to the housing; and
an intermediate portion extending between the central and peripheral portions, the intermediate portion including a flexible material relative to the central portion.

16. The system according to claim 15, wherein the central portion of the diaphragm comprises a rigid plate, and the intermediate portion comprises a convolute.

17. A method of controlling fuel vapor flow between a fuel vapor headspace of a fuel tank and a fuel vapor collection canister, the method comprising:
permitting with a fuel tank isolation valve the fuel vapor flow from the fuel vapor headspace of the fuel tank to fill the fuel vapor collection canister;
preventing with the fuel tank isolation valve the fuel vapor flow from the fuel vapor headspace of the fuel tank during purging of the fuel vapor collection canister; and
supplying vacuum to actuate the fuel tank isolation valve during refueling of the fuel tank.

18. The method according to claim 17, wherein the refueling comprises adding fuel to the fuel tank via a refueling tube, and the adding fuel drawing the vacuum in the refueling tube.

19. The method according to claim 18, wherein the supplying the vacuum comprises establishing a fluid coupling between the refueling tube and the fuel tank isolation valve so as to communicate the vacuum drawn in the refueling tube to the fuel tank isolation valve.

20. The method according to claim 17, wherein the supplying vacuum during refueling assists in the permitting the fuel vapor flow from the fuel vapor headspace of the fuel tank to the fuel vapor collection canister.
